(19) United States
(12) Patent Application Publication
(10) Pub. No.: US 2026/0370308 A1
(43) Pub. Date: Nov. 19, 2026

(54) Enhancements for Simultaneous Multi-Panel Transmissions

(71) Applicant: Apple Inc., Cupertino, CA (US)

(72) Inventors: Seyed Ali Akbar FAKOORIAN, San Diego, CA (US); Dawei ZHANG, Saratoga, CA (US); Haitong SUN, Saratoga, CA (US); Hong HE, San Jose, CA (US); Huaning NIU, San Jose, CA (US); Oghenekome OTERI, San Diego, CA (US); Wei ZENG, Saratoga, CA (US)

(21) Appl. No.: 19/155,711

(22) PCT Filed: Jan. 24, 2024
(86) PCT No.: PCT/US2024/012765

§ 371 Date: Aug. 12, 2025

Related U.S. Application Data
(60) Provisional application No. 63/484,777, filed on Feb. 14, 2023.

(51) Int. Cl. H04B 7/06; H04L 5/00; H04W 72/044; H04W 72/232

(52) U.S. Cl. CPC H04B 7/0697; H04L 5/0035; H04L 5/0094; H04W 72/046; H04W 72/232

(57) ABSTRACT

An apparatus configured to receive an indication related to simultaneous multi-panel transmission (STxMP) using a first transmission (Tx) panel and a second Tx panel for a Physical Uplink Shared Channel (PUSCH), wherein the indication comprises an association between Phase Tracking Reference Signals (PTRS) to be transmitted using the first and second Tx panels and Demodulation Reference Signals (DMRS) to be transmitted using the first and second Tx panels and transmit, based on the indication, the PUSCH to a first transmission and reception point (TRP) and a second TRP of a base station using the first and second Tx panels.

### BACKGROUND

A user equipment (UE) may support simultaneous multi-panel transmissions (STxMP). The UE may support one or both of a spatial domain multiplexing (SDM) scheme or a single frequency network (SFN) scheme in STxMP. However, there are many aspects of STxMP that remain undefined such as Phase Tracking Reference Signal (PTRS)—Demodulation Reference Signal (DMRS) association for SDM and SFN and dynamic switching between SFN and single Transmission and Reception Point (sTRP) operation.

### SUMMARY

Some example embodiments are related to an apparatus having processing circuitry configured to receive an indication related to simultaneous multi-panel transmission (STxMP) using a first transmission (Tx) panel and a second Tx panel for a Physical Uplink Shared Channel (PUSCH), wherein the indication comprises an association between Phase Tracking Reference Signals (PTRS) to be transmitted using the first and second Tx panels and Demodulation Reference Signals (DMRS) to be transmitted using the first and second Tx panels and configure transceiver circuitry to transmit, based on the indication, the PUSCH to a first transmission and reception point (TRP) and a second TRP of a base station using the first and second Tx panels.

Other example embodiments are related to an apparatus having processing circuitry configured to configure an indication related to simultaneous multi-panel transmission (STxMP) using a first transmission (Tx) panel and a second Tx panel for a Physical Uplink Shared Channel (PUSCH), wherein the indication comprises an association between Phase Tracking Reference Signals (PTRS) to be transmitted using the first and second Tx panels and Demodulation Reference Signals (DMRS) to be transmitted using the first and second Tx panels and configure transceiver circuitry to transmit the indication to a user equipment (UE) via a first transmission and reception point (TRP) or a second TRP.

### BRIEF DESCRIPTION OF THE DRAWINGS

FIG. 1 shows an example network arrangement according to various example embodiments.

FIG. 2 shows an example UE according to various example embodiments.

FIG. 3 shows an example base station according to various example embodiments.

FIG. 4 shows an example network arrangement with two transceiver points according to various example embodiments.

FIG. 5 that shows Table 7.3.1.1.2-2, Table 7.3.1.1.2-3 and Table 7.3.1.1.2-5 of TS 38.212.

### DETAILED DESCRIPTION

The example embodiments may be further understood with reference to the following description and the related appended drawings, wherein like elements are provided with the same reference numerals. The example embodiments relate to a UE performing simultaneous multi-panel transmissions (STxMP) using a spatial domain multiplexing (SDM) scheme or a single frequency network (SFN) scheme. Specifically, the example embodiments relate to defining associations between Phase Tracking Reference Signals (PTRS) and Demodulation Reference Signals (DMRS) for SDM and SFN. The example embodiments also relate to dynamic switching between SFN and single Transmission and Reception Point (sTRP) operation by the UE.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component.

The example embodiments are also described with regard to a fifth generation (5G) New Radio (NR) network and a next generation node B (gNB). However, reference to a 5G NR network and a gNB is merely provided for illustrative purposes. The example embodiments may also be implemented in other types of networks, including future evolutions of the cellular protocol, or any other type of network.

Throughout this description, the terms “configured” and “indicated” are used to describe the UE being sent information that the UE may use to perform operations, e.g., transmitting on the Physical Uplink Shared Channel (PUSCH).

Typically, the term configured is used when the UE is signaled the information using Radio Resource Control (RRC) signaling or the information is included in a Medium Access Control Control Element (MAC CE). The term indicated is typically used when the UE is signaled the information using Downlink Control Information (DCI). However, configured information may also be indicated and indicated information may also be configured.

Thus, while there are typical manners of signaling the information, the example embodiments are not limited by these manners.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

A UE that supports simultaneous multi-panel transmissions (STxMP) may have multiple transmission (Tx) panels that may be used to simultaneously transmit uplink (UL) signals the TRPs, e.g., a UL transmission to one TRP may be generated from two Tx panels of the UE. In the example embodiments, it may be considered that the UE has two Tx panels. However, the principles described herein for the example embodiments may be extended to UEs having more than 2 TX panels.

The example embodiments are also described with reference to a single Downlink Control Information (sDCI) scenario where the UE is instructed by a sDCI to transmit information in the uplink (UL) via a Physical Uplink Shared Channel (PUSCH).

The UE may also support one or both of a spatial domain multiplexing (SDM) scheme or a single frequency network (SFN) scheme. In SDM, different layers of the PUSCH transmission are transmitted using different Tx panels. For example, if the PUSCH has two layers, each layer will be transmitted using a different Tx panel. In another example, the PUSCH has three layers where a first layer is transmitted using a first Tx panel and the remaining two layers are transmitted using a second Tx panel (denoted as {1+2} ). In a still further example, the PUSCH has three layers where two layers is transmitted using a first Tx panel and the remaining layer is transmitted using a second Tx panel (denoted as {2+1} ).

In SFN, the same PUSCH information is transmitted on different Tx panels, e.g., if the sDCI indicates the PUSCH is to be transmitted using 2 layers, both of the 2 layers are transmitted using both Tx panels. Thus, the designation {1+1} and {2+2} may be used for SFN but it is different than the designation described above for SDM. For example, a {1+1} SFN transmission indicates the same information from one layer is transmitted on 2 Tx panels. A {2+2} SFN transmission indicates the same information from two layers are transmitted on 2 Tx panels.

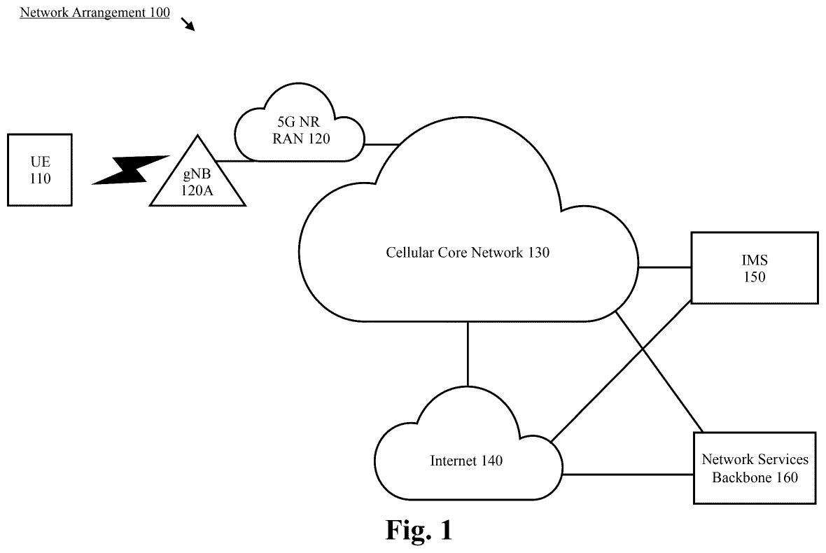

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IOT) devices, etc. An actual network arrangement may include any number of UEs being used by any number of users. Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120.

Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A.

However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

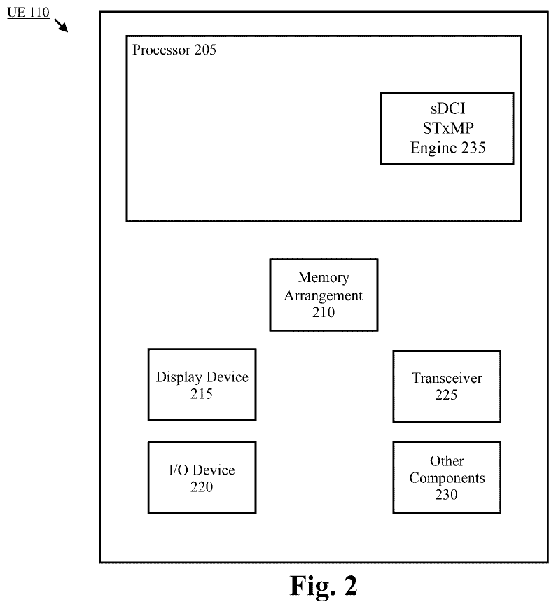

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an sDCI STxMP Engine 235 for performing operations such as receiving configurations and indications for STxMP operations, associating PTRS and DMRS, performing STxMP transmissions based on the configurations and indications and switching from a STxMP SFN scheme to a sTRP mode. These and other operations are described in greater detail below.

The above referenced engine being an application (e.g., a program) executed by the processor 205 is only an example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

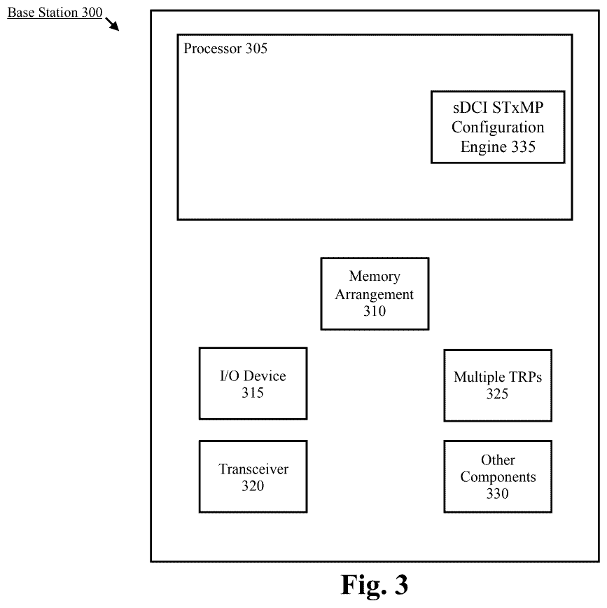

FIG. 3 shows an example base station 300 according to various example embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include sDCI STxMP Configuration Engine 335 for performing operations such as transmitting configurations and indications for STxMP operations to a UE, receiving STxMP transmissions from the UE based on the configurations and indications and indicating the UE should switch from a STAMP SFN scheme to a sTRP mode. These and other operations are described in greater detail below.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

In situations where two simultaneous DL receptions (e.g., two AoA receptions), procedures are needed such that both the network and the UE ensure that the UE receives both a new beam corresponding to an AoA₂ and an existing beam corresponding to an AoA₁ simultaneously. UEs operating in such scenarios may alternatively fall back to single DL (e.g., with AoA₁) reception, or the UE may resume two AoA reception by following procedures defined herein.

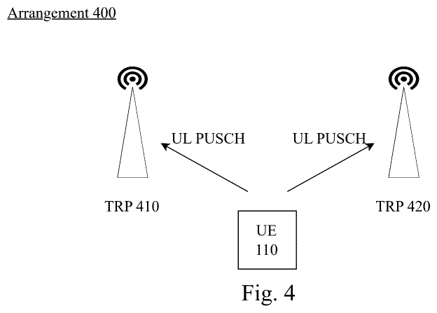

FIG. 4 shows an example network arrangement 400 with two TRPs according to various example embodiments. The network arrangement 400 includes a first TRP 410 and a second TRP 420.

The TRPs 410 and 420 communicate with UE 110. The UE 110 may comprise a plurality of reception (Rx) panels and transmission (Tx) panels. The Rx panels are used to receive signals from the TRPs 410 and 420. The example embodiments are generally related to the UE 110 transmitting signals to the TRPs 410 and 420 and therefore the Rx panels are not described in greater detail.

As shown in FIG. 4, the UE 110 will transmit uplink (UL) Physical Uplink Shared Channel (PUSCH) transmissions to the TRPs 410 and 420. It may be considered that each UL PUSCH transmission is transmitted via a separate Tx panel of the UE 110, e.g., the UL PUSCH transmission to the TRP 410 is transmitted via a first Tx panel and the UL PUSCH transmission to the TRP 420 is transmitted via a second Tx panel. As described above, these UL PUSCH transmissions to the TRPs 410 and 420 may be performed simultaneously by the UE, e.g., both Tx panels are activated at the same time to perform the transmissions. This is referred to as simultaneous multi-panel transmissions (STxMP). The example embodiments described below describe various aspects of STxMP operations.

As described above, the UE 110 may operate in sDCI based STxMP mode using a SDM scheme. In such PUSCH transmissions, 2 PTRS ports may be defined. This may lead to the issue of associating these PTRS ports with DMRS ports because in the SDM scheme each layer of the PUSCH will be transmitted using a different Tx panel. This means that there will be at least one DMRS port for each Tx panel. Recall the above examples where the PUSCH had three layers, e.g., denoted as {1+2} or {2+1}. In these examples, there would be 3 DMRS ports, e.g., in the {1+2} example, 1 DMRS port for the first Tx panel and 2 DMRS ports for the second Tx panel; and in the {2+1} example, 2 DMRS ports for the first Tx panel and 1 DMRS port for the second Tx panel.

Thus, in sDCI based STxMP SDM mode PTRS-DMRS association should be defined. The example embodiments are described with reference to information (e.g., a field) in DCI format 0_1 and 0_2 to signal this PTRS-DMRS association to the UE 110. While the example embodiments, are described with reference to DCI format 0_1 and 0_2, the principles described herein may apply to any sDCI indication when the UE 110 is operating in STxMP SDM mode.

In some example embodiments, the maximum number of layers per panel is indicated to be 1 (e.g., {1+1} ; 2 layers, 1 layer per panel). In these example embodiments, no bits are needed to signal the PTRS-DMRS association because it is implicit in the indication in the maximum number of layers per panel, e.g., the single PTRS port is mapped to the single DMRS port for each Tx panel.

In other example embodiments, the maximum number of layers per panel is indicated to be {1+2} or {2+1} as described above. In these examples, a 1-bit field may be used to signal the PTRS-DMRS association to the UE 110. Again, for the Tx panel used to transmit the single layer, the PTRS-DMRS association is again implicit, e.g., the single PTRS port is mapped to the single DMRS port. On the other hand, for the Tx panel being used to transmit the 2 layers, the 1-bit field may be used to signal the PTRS-DMRS association. For example, when the 1-bit field is set to a first value (e.g., ‘0’), the first scheduled DMRS port corresponds to the Sounding Reference Signal (SRS) resource set with a configured maximum of 2 layers. When the 1-bit field is set to a second value (e.g., ‘1’), the second scheduled DMRS port corresponds to the SRS resource set with a configured maximum of 2 layers.

In further example embodiments, the maximum number of layers per panel is indicated to be {2+2}, e.g., each Tx panel is used to transmit 2 layers of the PUSCH. In these examples, a 2-bit field may be used to signal the PTRS-DMRS association to the UE 110. In the 2-bit field a most significant bit (MSB) and a least significant bit (LSB) may be defined. The MSB may be used to signal the SRS resource indicator field and/or precoding information and a number of layers field. For example, when the MSB bit is set to a first value (e.g., ‘0’), the first scheduled DMRS port corresponds to the SRS resource indicator field and/or precoding information and a number of layers field. When the MSB bit is set to a second value (e.g., ‘1’), the second scheduled DMRS port corresponds to the SRS resource indicator field and/or precoding information and a number of layers field. The LSB may be used to signal the second SRS resource indicator field and/or precoding information. For example, when the LSB bit is set to a first value (e.g., ‘0’), the first scheduled DMRS port corresponds to the second SRS resource indicator field and/or precoding information. When the LSB bit is set to a second value (e.g., ‘1’), the second scheduled DMRS port corresponds to the second SRS resource indicator field and/or precoding information.

In the above example embodiments, the maximum number of layers per panel may be configured by the network and signaled to the UE 110 using, for example, Radio Resource Control (RRC) signaling. Thus, based on this information, the UE 110 will expect the corresponding number of bits in the sDCI related to the PTRS-DMRS association. However, the configured maximum number of layers may not be the indicated number of layers. To provide an example, the UE 110 may be configured using RRC signaling with a maximum number of layers as {2+1}.

This configured number of layers should be understood to be a maximum. Thus, sDCI may still indicate 2 layers, 1 layer per Tx panel because this does not violate the maximum of {2+1}. Thus, even though the UE 110 expects the sDCI to include the 1-bit field for PTRS-DMRS association in a {2+1} scenario, the UE 110 may understand that the 1-bit field is not needed when only 2 layers are indicated because the PTRS-DMRS association is similar to the {1+1} scenario. In these examples (e.g., where the indicated number of layers is less than the configured maximum number of layers), the 1-bit field in the sDCI may be ignored or repurposed for some other purpose.

Another issue related to PTRS-DMRS association in sDCI STxMP SDM mode, is that the configured maximum number of PTRS ports (e.g., the UE is configured with the higher layer parameter maxNrofPorts in PTRS-UplinkConfig set to ‘n2’) may be different from the actual number of UL PTRS port(s) for the associated transmission layer. For example, for non-codebook based UL transmission, a UE may be configured with the PTRS port index for each configured SRS resource by the higher layer parameter ptrs-PortIndex configured by SRS-Config if the UE is configured with the higher layer parameter phaseTrackingRS in DMRSUplinkConfig. Thus, if the PTRS port index associated with different SRS resource indicators (SRIs) are the same, the corresponding UL DMRS ports are associated to the one UL PT-RS port meaning that the configured maximum number of PTRS ports is 2 but the actual number of PTRS ports is 1. For codebook based UL transmission, the actual number of PTRS ports are indicated by transmit precoding matrix index (TPMI). A PUSCH antenna port 1000 and 1002 indicated in TPMI(s) share PT-RS port 0, and PUSCH antenna port 1001 and 1003 in indicated TPMI(s) share PT-RS port 1. Again, there may be scenarios where the configured maximum number of PTRS ports is 2 but the actual number of PTRS ports is 1. In STxMP mode, because there are two Tx panels transmitting simultaneously, some of these scenarios may result in a single PTRS port being mapped to 2 Tx panels. The UE will not be able to keep phase tracking across 2 Tx panels in these scenarios.

To resolve this issue, a UE operating in sDCI STAMP SDM mode may have a maxNrofPorts set to 1 per SRS resource set and the port-index, if configured, is different between the two SRS resource sets. This assures that for non-codebook based SDM STxMP, all SRS resources within a SRS resource set are associated with a single PTRS port which is different than that of the other SRS resource set. For example, all SRS resources within the first SRS resource set are associated with ptrs-PortIndex 0 and all SRS resources within the second SRS resource set are associated with ptrs-PortIndex 1.

Turning now to PTRS-DMRS association in sDCI STxMP SFN mode, DMRS ports are treated similar to the PUSCH data, e.g., the exact same DMRS are transmitted using both Tx panels. Since PTRS is associated with DMRS, SFN for DMRS means PTRS are also transmitted in the same manner, e.g., the exact same PTRS are transmitted using both Tx panels.

Prior to discussing the PTRS-DMRS association, the issue of the configured maximum number of PTRS ports and actual number of ports in SFN based STxMP is discussed. In some example embodiments, when a UE is configured with SFN based STxMP, the configured and actual number of UL PTRS ports are the same. As described above with reference to SDM, the actual number of PTRS ports may be different than the configured number of PTRS ports. However, in these example embodiments, when the UE is configured with SFN, the configured and actual number of UL PTRS ports will be considered to be the same.

Turning to PTRS-DMRS association, when the UE is configured with SFN based STxMP, in some example embodiments, a field may be used in the sDCI to signal the PTRS-DMRS association to the UE.

In a first example, when the transmission is a {1+1} SFN transmission, e.g., SFN transmission of a single layer, no additional field is needed because similar to the {1+1} SDM transmission, the information indicating an SFN transmission of a single layer implicitly indicates the PTRS-DMRS association, e.g., there is a single PTRS port and a single DMRS port for each Tx panel.

In a second example, a 1 bit field may be used for a layer combination of {2+2}, e.g., SFN transmission of two layers. In a first option of the second example, it may be considered that a number of configured PTRS ports is 1. In this option, when the 1 bit field is set to a first value (e.g., ‘0’), the one PTRS port may be mapped to the first scheduled DMRS port. When the 1 bit field is set to a second value (e.g., ‘1’), the one PTRS port may be mapped to the second scheduled DMRS port.

In a second option of the second example, it may be considered that a number of configured PTRS ports is 2. In this option, when the 1 bit field is set to a first value (e.g., ‘0’), the one PTRS port may be mapped to the first scheduled DMRS port the first PTRS port (e.g., PTRS port 0) maps to the first scheduled DMRS port and the second PTRS port (e.g., PTRS port 1) maps to second scheduled DMRS. When the 1 bit field is set to a second value (e.g., ‘1’), the second PTRS port (e.g., PTRS port 1) maps to the first scheduled DMRS port and first PTRS port (PTRS port 0) maps to the second scheduled DMRS.

As described above, another aspect of the example embodiments is to support DCI-based dynamic switching between SFN scheme of single-DCI based STxMP PUSCH and sTRP transmission. In some example embodiments, a DCI field “SRS resource set indicator” may be used to indicate the switching between the SFN scheme and sTRP transmissions. However, the example embodiments are not limited to this manner of signaling the UE to switch between the SFN scheme and sTRP transmissions.

An issue that arises based on dynamic switching between SFN and sTRP is that the maximum number of layers for sTRP transmission and SFN transmission may be different. This may affect the DCI size. For example, when the UE is configured with two SRS resource sets in SFN mode, the UE will assume it is operating in SFN mode when decoding the DCI. However, if DCI based dynamic switching is supported, the DCI should support both SFN and sTRP, e.g., the DCI should include information for both SFN and sTRP. This may lead to an unsatisfactory increase in the size of the DCI. The following provides multiple example embodiments for supporting the dynamic switching between SFN and STRP.

In a first example embodiment, for a UE configured with SFN STxMP, the only allowed combinations of maximum number of layers across panels are {1+1} or {2+2}. This restriction limits the number of layers used for SFN and may simplify the configuration in DCI because only up to four layers are supported for simultaneous transmission, e.g., a maximum of 2 x Layers (L).

In a second example embodiment, for a UE configured with SEN STAMP, DMRS antenna port indicates 1 or 2 ports that may be in the same or separate code division multiplexing (CDM) groups. The second example embodiment is related to the first example embodiment, e.g., because the maximum number of layers across panels are {1+1} or {2+2}, the number of DMRS ports may also be limited to 1 or 2 ports.

In a third example embodiment, the UE may be configured with simultaneous multi-TRP (mTRP) based SFN PUSCH transmissions. In these example embodiments, the UE may be configured with a pair (L_{Smax}, L_{Mmax}) of parameters related to a maximum number of layers. L_{Smax} may represent a maximum number of layers when the UE is indicated to switch back to sTRP. L_{Mmax} represents a maximum number of layers when the UE is indicated to perform SFN based mTRP transmissions.

In a fourth example embodiment, L_{Mmax} may be determined based on the maximum number of layers corresponding to the first and second SRS resource sets, respectively L_{1,Mmax} and L_{2,Mmax}, When the UE is indicated to perform simultaneous mTRP based SDM PUSCH transmissions. For example, in some example embodiments, L_{Mmax}=½ (L_{1,Mmax}+L_{2,Mmax}). In other example embodiments, L_{Mmax}=min (L_{1,Mmax}, L_{2,Mmax}). In still further example embodiments, L_{Mmax}=max (L_{1,Mmax}/L_{2,Mmax}).

The fourth example embodiment is related to the third example embodiment because the L_{Mmax} is the same, e.g., a maximum number of layers when the UE is indicated to perform SFN based mTRP transmissions. However, in the fourth example embodiment, the UE may not be directly signaled the value of L_{Mmax} but the UE may derive the value based on a relationship between SDM and SFN parameters. This allows a saving in RRC parameter signaling because the value of L_{Mmax} does not need to be signaled to the UE because the UE can derive the value.

In a fifth example embodiment, for a UE configured with SEN STxMP with two SRS resource sets (e.g., N₁ and N₂) with usage set to ‘nonCodebook,’ each SRS resource set may have more than one SRS resources. Moreover, each SRS resource set may support a different number of SRS resources per set, e.g., N_{1,SRS} and N_{2,SRS} for all (L_{Smax}, L_{Mmax}) combinations when L_{Mmax}=2. This allows for more flexibility at the scheduler and enhances the SFN transmission. In this example embodiment, the value of L_{Smax} (e.g., the maximum number of layers for STRP) does not matter, e.g., the value of L_{Smax} may be 1, 2, 3 or 4. The DCI size for SRI supports switching between mTRP SFN and sTRP, e.g., all combinations of resource sets may be supported.

In a sixth example embodiment, the UE is configured in the same manner as the fifth example embodiment, except that L_{Mmax}=1. Similar to the fifth example, all combinations of resource sets may be supported, with some exceptions. For example, when L_{Smax}=2, 3, 4 and (N_{1,SRS}=2 and N_{2,SRS}=4) or (N_{1,SRS}=4 and N_{2,SRS}=2, where N_{j,SRS} is a number of SRS resources within the jth SRS resource set. The issue with these exceptions is that the DCI size for sTRP may be larger than the DCI for mTRP SFN. These exceptions are implemented because the UE assumes that the DCI is for mTRP SFN, e.g., when the UE decodes the DCI, the UE does not know it is being dynamically switched to sTRP. By excluding these specific combinations, it assures that switching to sTRP will result in a SRI bit-field that is not larger than SRI₁+SRI₂.

In a seventh example embodiment, for a UE configured with SEN STxMP with two SRS-ResourceSets with usage set to ‘codebook,’ the UE is not expected to be configured with different number of SRS resources in the two SRS resource sets.

In an eighth example embodiment, for a UE configured with SFN STxMP with two SRS-ResourceSets with usage set to ‘codebook,’ the UE may be configured and indicated with different higher layer parameters nrofSRS-Ports in SRS-Resource in different SRS-ResourceSets. Allowing the different numbers of ports allows for an improvement in the system performance, e.g., allows for different pre-coders for different Tx panels. However, to keep the DCI size the same for SFN and sTRP, there is an antenna port combination that is excluded, e.g., because the sTRP combination requires more DCI bits than SFN. This exclusion will be described in greater detail below.

Similar to the non-codebook based transmissions, the UE will assume that the DCI is for SFN and when, decoding the DCI, the UE determines the two TPMI bit-fields associated with each SRS resource set, TPMI₁ and TPMI₂, based on existing Rel-16 tables in TS 38.212, where a size of TPMI₂ is a function of TPMI₁. Again, except for the exclusions described below, this design assures for sTRP operation, the size of the TMPI bit-field associated to the indicated SRS resource set is not larger than size of (TPMI₁+TPMI₂).

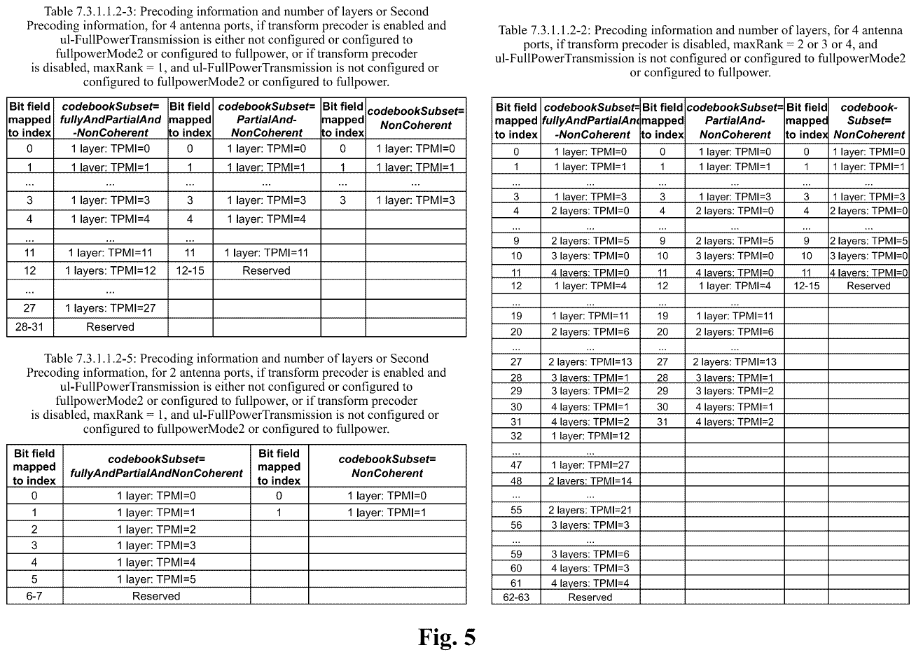

The exclusion will be described with reference to FIG. 5 that shows Table 7.3.1.1.2-2, Table 7.3.1.1.2-3 and Table 7.3.1.1.2-5 of TS 38.212. It may be considered that (L_{Smax}, L_{Mmax})=(L_{Smax}, 1), (N_{ap,SRS1}= 4/2 and N_{ap,SRS2}= 4/2), where Nₐₚ is the number of antenna ports per SRS resource set. It may also be considered that L_{Mmax}=1 and L_{Smax} may be 1, 2, 3 or 4. The exclusion applies when the codebookSubset is non-coherent, the first resource set (e.g., SRS1) has 4 antenna ports and the second resource set (e.g., SRS2) has 2 antenna ports and the STRP uses the first resource set. The exclusion also applies when the codebookSubset is non-coherent, the first resource set (e.g., SRS1) has 2 antenna ports and the second resource set (e.g., SRS2) has 4 antenna ports and the sTRP uses the second resource set. As described above, these scenarios are excluded because the number of DCI bits for sTRP for this scenario is greater than the number of DCI bits for SFN.

To provide an example of the exclusion, reference is made to FIG. 5. This example is the exclusion when the codebookSubset is non-coherent, the first resource set (e.g., SRS1) has 4 antenna ports and the second resource set (e.g., SRS2) has 2 antenna ports and the sTRP uses the first resource set. Initially, referring to Table 7.3.1.1.2-3, it can be seen that the last two columns refer to the scenario where codebookSubset is non-coherent for SFN. As can be seen from this table, for SFN, there are 4 TPMI indices (0-3) for the resource set having 4 antenna ports (e.g., SRS1), meaning that a 2-bit field is needed in DCI to provide this information to the UE.

Now referring to Table 7.3.1.1.2-3, it can be seen that the last two columns refer to the scenario where codebookSubset is non-coherent for SEN. As can be seen from this table, for SFN, there are 2 TPMI indices (0-1) for the resource set having 2 antenna ports (e.g., SRS2), meaning that a 1-bit field is needed in DCI to provide this information to the UE. Thus, for SFN, the DCI needs 3-bits (e.g., 2+1) for the above described scenario.

In contrast, referring to Table 7.3.1.1.2-2, it can be seen that the last two columns refer to the scenario where codebookSubset is non-coherent for sTRP. As can be seen from this table, for sTRP, there are 12 TPMI indices (0-11) for the resource set having 4 antenna ports (e.g., SRS1), meaning that a 4-bit field is needed in DCI to provide this information to the UE. Thus, the number of bits for sTRP (4-bits) is greater than the number of bits for SFN (3-bits). This would lead to the DCI for sTRP being larger than the DCI for SFN which is not allowed under this example embodiment. Therefore, this particular scenario is excluded. The other exclusion can be determined in the same manner.

However, as described above, all other combinations of antennas ports support SFN and sTRP switching.

### Examples

In a first example, a method performed by a user equipment (UE) comprising a first transmission (Tx) panel and a second Tx panel, the method comprising receiving an indication related to simultaneous multi-panel transmission (STxMP) using the first and second Tx panels for a Physical Uplink Shared Channel (PUSCH), wherein the indication comprises an association between Phase Tracking Reference Signals (PTRS) to be transmitted using the first and second Tx panels and Demodulation Reference Signals (DMRS) to be transmitted using the first and second Tx panels and transmitting, based on the indication, the PUSCH to a first transmission and reception point (TRP) and a second TRP of a base station using the first and second Tx panels.

In a second example, the method of the first example, wherein the indication is received via Downlink Control Information (DCI) from one of the first or second TRPs.

In a third example, the method of the first example, wherein the UE is configured with STxMP using a spatial domain multiplexing (SDM) scheme, wherein different layers of the PUSCH are transmitted using different Tx panels.

In a fourth example, the method of the third example, wherein the indication comprises a maximum number of one layer for the first and second Tx panels and wherein the association between the PTRS and DMRS is based on the maximum number of one layer for the first and second Tx panels.

In a fifth example, the method of the third example, wherein the indication comprises a maximum number of two layers for the first Tx panel and a maximum number of 1 layer for the second Tx panel, the indication further comprising a 1-bit field to indicate the association between the PTRS and DMRS for the first Tx panel.

In a sixth example, the method of the fifth example, wherein a first value of the 1-bit field indicates an association between a first PTRS and a first scheduled DMRS port of a Sounding Reference Signal (SRS) resource set corresponding to the first Tx panel and a second value of the 1-bit field indicates an association between the first PTRS and a second scheduled DMRS port of the SRS resource set corresponding to the first Tx panel.

In a seventh example, the method of the third example, wherein the indication comprises a maximum number of two layers for the first Tx and second Tx panels, the indication further comprising a 2-bit field to indicate the association between the PTRS and DMRS for the first and second Tx panels, wherein a most significant bit (MSB) of the 2-bit field indicates (i) a first SRS resource indicator field or (ii) first precoding information and (iii) a number of layers field, f and wherein a least significant bit (LSB) of the 2-bit field indicates a second SRS resource indicator field or second precoding information.

In an eighth example, the method of the seventh example, wherein a first value of the MSB indicates a first scheduled DMRS port corresponds to the first SRS resource indicator field or first precoding information and a second value of the MSB indicates a second scheduled DMRS port corresponds to the first SRS resource indicator field or first precoding information.

In a ninth example, the method of the seventh example, wherein a first value of the LSB indicates a first scheduled DMRS port corresponds to the second SRS resource indicator field or second precoding information and a second value of the LSB indicates a second scheduled DMRS port corresponds to the second SRS resource indicator field or second precoding information.

In a tenth example, the method of the third example, wherein, when operating using the SDM scheme, a first Sounding Reference Signal (SRS) resource set corresponds to the first Tx panel and a second SRS resource set corresponds to the second Tx panel, wherein a maximum number of ports per SRS resource set is one.

In an eleventh example, the method of the tenth example, wherein a port-index is different between the first and second SRS resource sets.

In a twelfth example, the method of the first example, wherein the UE is configured with STxMP using a single frequency network (SFN) scheme, wherein each layer of the PUSCH is transmitted using both the first and second Tx panels.

In a thirteenth example, the method of the twelfth example, wherein a configured number of PTRS ports and an actual number of PTRS ports are the same.

In a fourteenth example, the method of the twelfth example, wherein the indication indicates the PUSCH comprises one layer, wherein the association between the PTRS and DMRS is based on the indication of one layer PUSCH.

In a fifteenth example, the method of the twelfth example, wherein the indication indicates the PUSCH comprises two layers and wherein there is one configured PTRS port per Tx panel, the indication further comprising a 1-bit field to indicate the association between the PTRS and DMRS for the first and second Tx panels.

In a sixteenth example, the method of the fifteenth example, wherein a first value of the 1-bit field indicates an association, for each Tx panel, between the configured PTRS port and a first scheduled DMRS port, and a second value of the 1-bit field indicates an association, for each Tx panel, between the configured PTRS port and a second scheduled DMRS port.

In a seventeenth example, the method of the twelfth example, wherein the indication indicates the PUSCH comprises two layers and wherein there is two configured PTRS ports per Tx panel, the indication further comprising a 1-bit field to indicate the association between the PTRS and DMRS for the first and second Tx panels In an eighteenth example, the method of the seventeenth example, wherein, a first value of the 1-bit field indicates an association, for each Tx panel, between a first of the configured PTRS ports and a first scheduled DMRS port and a second of the configured PTRS ports and a second scheduled DMRS port, and a second value of the 1-bit field indicates an association, for each Tx panel, between the second of the configured PTRS ports and the first scheduled DMRS port and a first of the configured PTRS ports and the second scheduled DMRS port.

In a nineteenth example, the method of the twelfth example, wherein the UE supports switching from the STxMP using the SFN scheme to single TRP (STRP) mode based on information included in the indication, wherein the indication is received via Downlink Control Information (DCI) from one of the first or second TRPs.

In a twentieth example, the method of the nineteenth example, wherein a maximum number of layers for PUSCH for STxMP using the SFN scheme is two.

In a twenty first example, the method of the nineteenth example, wherein a maximum number of DMRS antenna ports per Tx panel is two.

In a twenty second example, the method of the twenty first example, wherein the DMRS antenna ports are in a same code division multiplexing (CDM) group or a different CDM group.

In a twenty third example, the method of the nineteenth example, wherein the indication comprises a maximum number of layers (L_{Smax}) when the UE is indicated to switch to STRP and a maximum number of layers (L_{Mmax}) when the UE is indicated to perform SFN based multi-TRP (mTRP) transmissions.

In a twenty fourth example, the method of the nineteenth example, wherein the UE is indicated a first maximum number of layers (L_{1,Mmax}) corresponding to a first Sounding Reference Signal (SRS) resource set and a second maximum number of layers (L_{2,Mmax}) corresponding to a second SRS resource set when the UE is indicated to perform simultaneous mTRP based spatial domain multiplexing (SDM) PUSCH transmissions, the method further comprising determining a maximum number of layers (L_{Mmax}) when the UE is indicated to perform SFN based mTRP transmissions based on at least values of L_{1,Mmax} and L_{2,Mmax}.

In a twenty fifth example, the method of the twenty fourth example, wherein the L_{Mmax} is determined based on L_{Mmax}=½ (L_{1,Mmax}+L_{2,Mmax}).

In a twenty sixth example, the method of the twenty fourth example, wherein the L_{Mmax} is determined based on L_{Mmax}=min (L_{1,Mmax}, L_{2,Mmax}).

In a twenty seventh example, the method of the twenty fourth example, wherein the L_{Mmax} is determined based on L_{Mmax}=max (L_{1,Mmax}, L_{2,Mmax}).

In a twenty eighth example, the method of the nineteenth example, wherein the UE is configured with two Sounding Reference Signal (SRS) resource sets with usage set to nonCodebook, wherein each SRS resource set comprises more than one SRS resource, wherein a different number of SRS resources are configured for each SRS resource set, and wherein the UE Supports switching from the STxMP using the SFN scheme to sTRP mode for all combinations of a maximum number of layers (L_{Smax}) when the UE is indicated to switch to sTRP and a maximum number of layers (L_{Mmax}) when the UE is indicated to perform SEN based multi-TRP (mTRP) when L_{Mmax}=2.

In a twenty ninth example, the method of the nineteenth example, wherein the UE is configured with two Sounding Reference Signal (SRS) resource sets with usage set to nonCodebook, wherein each SRS resource set comprises more than one SRS resource, wherein a different number of SRS resources are configured for each SRS resource set, and wherein the UE supports switching from the STxMP using the SFN scheme to sTRP mode for all combinations of a maximum number of layers (L_{Smax}) when the UE is indicated to switch to sTRP and a maximum number of layers (L_{Mmax}) when the UE is indicated to perform SFN based multi-TRP (mTRP) when L_{Mmax}=1, except when L_{Smax}=2, 3, or 4 and a first or second SRS resource set comprises four SRS resources and an other one of the first or second SRS resource set comprises two SRS resources.

In a thirtieth example, the method of the nineteenth example, wherein the UE is configured with two Sounding Reference Signal (SRS) resource sets with usage set to Codebook, wherein each SRS resource set comprises more than one SRS resource, wherein each SRS resource set comprises a same number of SRS resources.

In a thirty first example, the method of the thirtieth example, wherein the UE is configured or indicated with a first number of SRS ports for a first SRS resource set and a second number of SRS ports for a second SRS resource set, except when the first SRS resource set comprises four SRS ports, the second SRS resource set comprises two SRS ports, the codebook subset is set to non-coherent and sTRP uses the first SRS resource set, or when the first SRS resource set comprises two SRS ports, the second SRS resource set comprises four SRS ports, the codebook subset is set to non-coherent and sTRP uses the second SRS resource set.

In a thirty second example, a processor configured to perform any of the methods of the first through thirty first examples.

In a thirty third example, a user equipment comprising a transceiver configured to communicate with a base station and a processor communicatively coupled to the transceiver and configured to perform any of the methods of the first through thirty first examples.

In a thirty fourth example, a method performed by a base station comprising a first transmission and reception point (TRP) and a second TRP, comprising receiving information from a user equipment (UE) indicating the UE supports switching from simultaneous multi-panel transmission (STxMP) using a single frequency network (SFN) scheme to single TRP (sTRP) mode based on Downlink Control Information (DCI) received from one of the first or second TRPs, transmitting configuration information to the UE related to STxMP using SFN, wherein the configuration information comprises two Sounding Reference Signal (SRS) resource sets with usage set to Codebook, wherein each SRS resource set comprises more than one SRS resource, wherein each SRS resource set comprises a same number of SRS resources, wherein the configuration information further comprises a first number of SRS ports for a first SRS resource set and a second number of SRS ports for a second SRS resource set, except when the first SRS resource set comprises four SRS ports, the second SRS resource set comprises two SRS ports, the codebook subset is set to non-coherent and sTRP uses the first SRS resource set, or when the first SRS resource set comprises two SRS ports, the second SRS resource set comprises four SRS ports, the codebook subset is set to non-coherent and sTRP uses the second SRS resource set.

In a thirty fifth example, a processor of a base station configured to perform the thirty fourth example.

In a thirty sixth example, a base station comprising a transceiver configured to communicate with a user equipment (UE) and a processor communicatively coupled to the transceiver and configured to perform the thirty fourth example.

Those skilled in the art will understand that the above-described example embodiments may be implemented in any suitable software or hardware configuration or combination thereof. An example hardware platform for implementing the example embodiments may include, for example, an Intel ×86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
receive an indication related to simultaneous multi-panel transmission (STxMP) using a first transmission (Tx) panel and a second Tx panel for a Physical Uplink Shared Channel (PUSCH), wherein the indication comprises an association between Phase Tracking Reference Signals (PTRS) to be transmitted using the first and second Tx panels and Demodulation Reference Signals (DMRS) to be transmitted using the first and second Tx panels; and
configure transceiver circuitry to transmit, based on the indication, the PUSCH to a first transmission and reception point (TRP) and a second TRP of a base station using the first and second Tx panels.

2. The apparatus of claim 1, wherein the indication is received via Downlink Control Information (DCI) from one of the first or second TRPs.

3. The apparatus of claim 1, wherein the apparatus is configured with STxMP using a spatial domain multiplexing (SDM) scheme, wherein different layers of the PUSCH are transmitted using different Tx panels.

4. The apparatus of claim 3, wherein the indication comprises a maximum number of one layer for the first and second Tx panels and wherein the association between the PTRS and DMRS is based on the maximum number of one layer for the first and second Tx panels.

5. The apparatus of claim 3, wherein the indication comprises a maximum number of two layers for the first Tx panel and the second Tx panel, the indication further comprising a 2-bit field to indicate the association between the PTRS and DMRS for the first and second Tx panels,
wherein a most significant bit (MSB) of the 2-bit field indicates (i) a first SRS resource indicator field or (ii) first precoding information and (iii) a number of layers field, and
wherein a least significant bit (LSB) of the 2-bit field indicates a second SRS resource indicator field or second precoding information.

6. The apparatus of claim 5, wherein a first value of the MSB indicates a first scheduled DMRS port corresponds to the first SRS resource indicator field or first precoding information and a second value of the MSB indicates a second scheduled DMRS port corresponds to the first SRS resource indicator field or first precoding information.

7. The apparatus of claim 5, wherein a first value of the LSB indicates a first scheduled DMRS port corresponds to the second SRS resource indicator field or second precoding information and a second value of the LSB indicates a second scheduled DMRS port corresponds to the second SRS resource indicator field or second precoding information.

8. The apparatus of claim 1, wherein the apparatus is configured with STxMP using a single frequency network (SFN) scheme, wherein each layer of the PUSCH is transmitted using both the first and second Tx panels.

9. The apparatus of claim 8, wherein the apparatus supports switching from the STxMP using the SFN scheme to single TRP (STRP) mode based on information included in the indication, wherein the indication is received via Downlink Control Information (DCI) from one of the first or second TRPs.

10. The apparatus of claim 9, wherein the indication comprises a maximum number of layers (L_{Smax}) when the apparatus is indicated to switch to sTRP and a maximum number of layers (L_{Mmax}) when the apparatus is indicated to perform SFN based multi-TRP (mTRP) transmissions.

11. The apparatus of claim 1, wherein the apparatus comprises a processor of a user equipment (UE) or a UE.

12. An apparatus comprising processing circuitry configured to:
configure an indication related to simultaneous multi-panel transmission (STxMP) using a first transmission (Tx) panel and a second Tx panel for a Physical Uplink Shared Channel (PUSCH), wherein the indication comprises an association between Phase Tracking Reference Signals (PTRS) to be transmitted using the first and second Tx panels and Demodulation Reference Signals (DMRS) to be transmitted using the first and second Tx panels; and
configure transceiver circuitry to transmit the indication to a user equipment (UE) via a first transmission and reception point (TRP) or a second TRP.

13. The apparatus of claim 12, wherein the processing circuitry is further configured to:
receive, based on the indication, the PUSCH, wherein the PUSCH is received from the first TRP and the second TRP.

14. The apparatus of claim 12, wherein the indication is transmitted via Downlink Control Information (DCI) from one of the first or second TRPs.

15. The apparatus of claim 12, wherein the indication comprises a maximum number of one layer for the first and second Tx panels and wherein the association between the PTRS and DMRS is based on the maximum number of one layer for the first and second Tx panels.

16. The apparatus of claim 12, wherein the indication comprises a maximum number of two layers for the first and second Tx panels, the indication further comprising a 2-bit field to indicate the association between the PTRS and DMRS for the first and second Tx panels,
wherein a most significant bit (MSB) of the 2-bit field indicates (i) a first SRS resource indicator field or (ii) first precoding information and (iii) a number of layers field, and
wherein a least significant bit (LSB) of the 2-bit field indicates a second SRS resource indicator field or second precoding information.

17. The apparatus of claim 16, wherein a first value of the MSB indicates a first scheduled DMRS port corresponds to the first SRS resource indicator field or first precoding information and a second value of the MSB indicates a second scheduled DMRS port corresponds to the first SRS resource indicator field or first precoding information.

18. The apparatus of claim 16, wherein a first value of the LSB indicates a first scheduled DMRS port corresponds to the second SRS resource indicator field or second precoding information and a second value of the LSB indicates a second scheduled DMRS port corresponds to the second SRS resource indicator field or second precoding information.

19. The apparatus of claim 12, wherein the processing circuitry is further configured to:
receive information from the UE indicating the UE supports switching from simultaneous multi-panel transmission (STxMP) using a single frequency network (SFN) scheme to single TRP (STRP).

20. The apparatus of claim 19, wherein the indication comprises a maximum number of layers (L_{Smax}) when the UE is indicated to switch to STRP and a maximum number of layers (L_{Mmax}) when the UE is indicated to perform SFN based multi-TRP (mTRP) transmissions.
